(19) United States
(12) Patent Application Publication
(10) Pub. No.: US 2016/0188609 A1
(43) Pub. Date: Jun. 30, 2016

(54) System and Method for Model-based Search and Retrieval of Networked Data

(71) Applicant: Futurewei Technologies, Inc., Plano, TX (US)

(72) Inventor: John Charles Strassner, San Jose, CA (US)

(21) Appl. No.: 14/585,130

(22) Filed: Dec. 29, 2014

(51) Int. Cl. G06F 17/30; G06F 17/27

(52) U.S. Cl. CPC G06F 17/3071; G06F 17/272; G06F 17/2785; G06F 17/2755; G06F 17/277; G06F 17/30684

(57) ABSTRACT

A method for processing a query includes parsing the query into part of speech (POS) tokens, categorizing the POS tokens into content tokens and context tokens, and mapping the content tokens to a first set of model elements. The method also includes mapping the context tokens to a second set of model elements, mapping the first and second sets of model elements into a set of combined model elements, and producing a set of extensible markup language (XML) schema definition(s) (XSD) files from the first, and second sets of model elements, and the set of combined model elements.

### TECHNICAL FIELD

The present disclosure relates generally to digital communications, and more particularly to a system and method for model-based search and retrieval of networked data.

### BACKGROUND

Communications systems have changed life in the modern world by enabling access to a wide range of services by different types of users. As an example, a first user may remotely access a work computer using a laptop from home or a conference room while on a business trip, a second user may visually verify that his children has arrived home safely from a day at school on his desktop computer at work, a third user may watch a favorite movie on a smart telephone, a fourth user may initiate the cooking of dinner from a digital tablet, and the like.

In order to support such a wide range of users, services, and access technologies, the communications systems have become increasingly complex. Additionally, the number of hardware and software components, as well as hardware and software types, making up the communications systems has also increased. The increased complexity of the communications systems, along with increased number and type of hardware and software components, help to make the configuration and management of the communications systems more difficult and potentially error prone.

### SUMMARY OF THE DISCLOSURE

Example embodiments of the present disclosure which provide a system and method for model-based search and retrieval of networked data.

In accordance with an example embodiment of the present disclosure, a method for processing a query is provided. The method includes parsing the query into part of speech (POS) tokens, categorizing the POS tokens into content tokens and context tokens, and mapping the content tokens to a first set of model elements. The method also includes mapping the context tokens to a second set of model elements, mapping the first and second sets of model elements into a set of combined model elements, and producing a set of extensible markup language (XML) schema definition(s) (XSD) files from the first, and second sets of model elements, and the set of combined model elements.

In accordance with another example embodiment of the present disclosure, a query processing device is provided. The query processing device includes a processor, and a memory operatively coupled to the processor. The processor parses a query into part of speech (POS) tokens, categorizes the POS tokens into content tokens and context tokens, maps the content tokens to a first set of model elements, maps the context tokens to a second set of model elements, maps the first and second sets of model elements into a set of combined model elements, and produces a set of extensible markup language (XML) schema definition(s) (XSD) files from the first and second sets of model elements, and the set of combined model elements. The memory stores the query, the model elements, and the XSD files.

In accordance with another example embodiment of the present disclosure, a management environment is provided. The management environment includes a communications system being managed, and a management entity operatively coupled to the communications system. The management entity parses a query into part of speech (POS) tokens, categorizes the POS tokens into content tokens and context tokens, maps the content tokens to a first set of model elements, maps the context tokens to a second set of model elements, maps the first and second sets of model elements into a set of combined model elements, and produces a set of extensible markup language (XML) schema definition(s) (XSD) files from the first and second sets of model elements, and the set of combined model elements.

One advantage of an embodiment is that the use of metadata allows for better description of dependencies that exist between components in a query to enhance the collection of data used in the management of a communications system.

A further advantage of an embodiment is that knowledge present in an information model is used to identify objects specified in a query.

A further advantage of an embodiment is that objects being managed may be found even when not explicitly specified in a search.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1a illustrates an example managed environment, in which a first entity is managing a second entity according to example embodiments described herein;

FIG. 1b illustrates an example of a managed environment, consisting of a management system and a second entity according to example embodiments described herein;

FIG. 2a illustrates an example a relationship and mapping between an information model and a set of data models according to example embodiments described herein;

FIG. 2b illustrates an example relationship between the semantics (i.e., understanding) of data and connectedness (i.e., how those data relate to each other and to the current or future context of the system being managed) for data according to example embodiments described herein;

FIG. 3 illustrates an example system including a communications system with an information model based management system according to example embodiments described herein;

FIG. 4 illustrates an example management system with detail provided for the salient functions of a portion of the management system according to example embodiments described herein;

FIG. 5 illustrates a detailed view of components of an example management system according to example embodiments described herein;

FIG. 6 illustrates a flow diagram of example operations occurring in processing a query of network data according to example embodiments described herein;

FIG. 7 illustrates a flow diagram of example operations occurring in mapping tokens to model elements according to example embodiments described herein;

FIG. 8 illustrates a flow diagram of example operations occurring in relating of terms to one or more model elements according to example embodiments described herein; and

FIG. 9 provides an example device according to example embodiments described herein.

### DETAILED DESCRIPTION OF ILLUSTRATIVE EMBODIMENTS

The operating of the current example embodiments and the structure thereof are discussed in detail below. It should be appreciated, however, that the present disclosure provides many applicable inventive concepts that can be embodied in a wide variety of specific contexts. The specific embodiments discussed are merely illustrative of specific structures of the disclosure and ways to operate the disclosure, and do not limit the scope of the disclosure.

Most networks are made up of heterogeneous devices from different vendors that are programmed using different languages, commands, and data formats and structures. This isolates information and data, and increases the overall complexity in finding, using and reusing, and changing network data. In addition, networks and network systems change their behavior, but different changes affect different entities in different ways.

These and other related problems make it very difficult to build a management system that can provide a menu of choices that enables an operator to retrieve the correct data, simply and easily. This disclosure addresses these and other related problems by using an information model to define a common vocabulary that enables disparate data to be related to a common lexicon. This is then mapped to one or more data models to take advantage of the different capabilities (e.g., storage, processing, and querying) offered by different platforms.

An information model represents the managed environment in terms of a set of objects. Each object has a set of attributes, and can potentially be related to other objects. This facilitates reuse. For example, a router is not a single entity with hundreds of attributes, but rather a collection of objects that model different concepts. Each concept, such as a card or a port, can be reused by other managed entities. In this manner, different networked entities that provide different functionality, such as a router and a server, can reuse common elements (e.g., the port and the card in this example).

In addition, the use of an information model ensures that different platforms can represent data in an optimal way that can be related to a single “source of truth”. More importantly, the information model provides structure for representing information that is independent of data type, protocol, and language; this enables the model to be used to represent information in a common way.

An information model represents managed objects and their attributes and relationships. It also can represent metadata (i.e., data about data). For example, a common versioning scheme could be defined independent of vendor device, protocol, and language, enabling disparate data to be treated as belonging to the same system and represented in an appropriate manner. Metadata can also be used to direct how behavior should be altered (e.g., according to changes in context).

Example embodiments of this disclosure provides more powerful and efficient searching of network devices, data that they produce, services provided by the network, and relationships between network devices. Furthermore, the complexity of finding network information is reduced. This is provided by using an information model in conjunction with one or more data models. Specifically, the models provide a common vocabulary that enables different data from different devices in different languages and formats to be related to each other. Additionally, metadata enables the meaning of disparate data to be encoded and used to reason about the data collected.

One example embodiment of the disclosure uses an information model as a common vocabulary to enable different data from different vendors to be referenced against a common lexicon. Another example embodiment uses the DEN-ng information model, or another model that has similar characteristics, structure, and representation of managed elements as DEN-ng does.

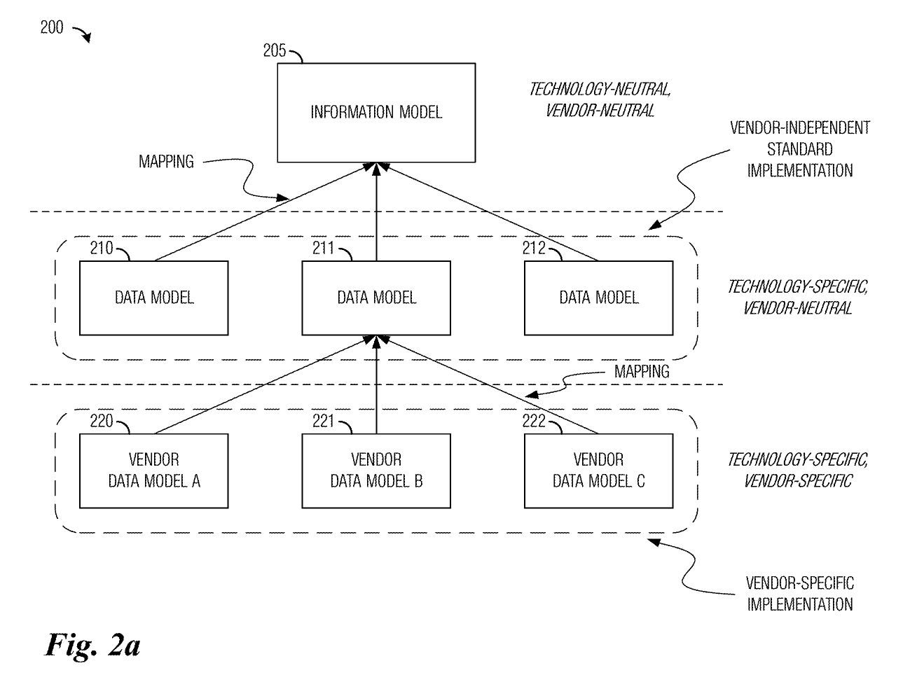

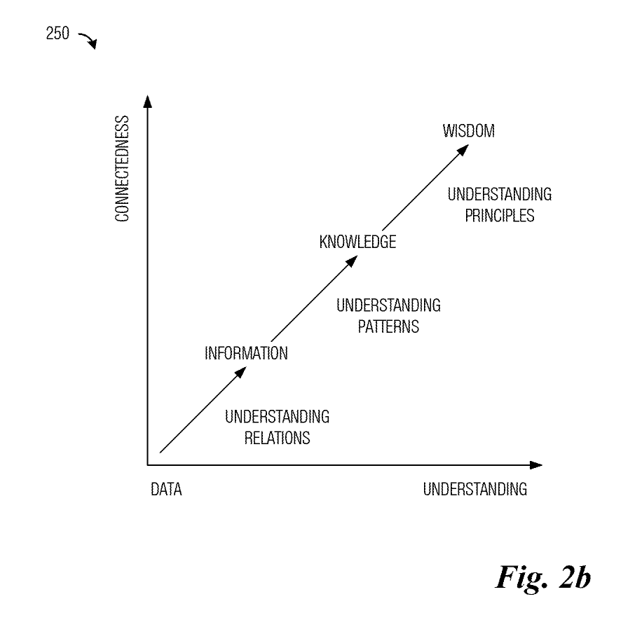

Another example embodiment of the disclosure enables a set of data models to be defined from a single information model using a set of model mappings, as illustrated in FIG. 2a, that each provide functionality that enables one or more characteristics of the data being represented and searched for to be represented in an optimal way.

Another example embodiment of the disclosure enables data and objects of interest to be identified directly or indirectly in the query for said data and objects. This is true even if the query does not contain key words or other language that explicitly maps to the data or objects that are being searched for. Another example embodiment uses the DEN-ng information model, which represents managed objects and data used in telecommunications systems.

Another example embodiment of the disclosure enables data to be found according to the characteristics and/or behavior of the data. Such characteristics and data can be described by a variety of means. An example embodiment uses metadata for this purpose. Accordingly, it defines metadata as part of the information model, so that metadata can be used with elements of the information model to search, match, and retrieve data. This means that names or other identifying information is not needed to retrieve the data. For example, data can be retrieved that matches the meaning of the query, as opposed to specific words in the query.

Another example embodiment of the disclosure enables context to be extracted from the query and used to find data and information. For example, the same object can match or not match a query depending on time of day, geographic location, customer, or other contextual information specified in the query. An example embodiment defines context using a combination of metadata and other model elements of the information model.

Another example embodiment of the disclosure enables the above elements to be used in combination to define a query using terms that are natural to the author of the query, instead of being constrained to using terms that the management system knows. For example, instead of saying “the border router of autonomous system 100 (AS100)”, the user can specify any routes for Service Provider X, where X peers with AS100. An example embodiment uses linguistic analysis, in conjunction with metadata and other model elements of the information model, to translate between terminology used by the author of the query and terminology used in the management system.

Another example embodiment of the disclosure enables dependencies between different elements of the query (e.g., data, protocol(s) used to retrieve the data, as well as storage and processing operations performed on the retrieved data, to be extracted from the query and compared to dependencies present in the information model. This enables said dependencies to be taken into account when querying data. In addition, it requires the management system itself to be reconfigured and optimized in the querying and retrieving of data. An example embodiment defines such dependencies using a combination of metadata and other model elements of the information model.

Another example embodiment of the disclosure enables the results of the query to be converted into a common format. An example implementation of the disclosure will translate the query results into XML for generic portability among platforms, as well as be capable of producing other data encodings (e.g., JSON, or Protocol Buffers).

The present disclosure will be described with respect to example embodiments in a specific context, namely a model-based management system for a communications system, wherein the management system utilizes models to enhance the quality searches of the data being collected. The communications system may be a standards compliant communications system, such as 3GPP LTE, WiMAX, IEEE 802.11, IEEE 802.16, and the like, a non-standards compliant communications system, or a combination of one or more technical standards compliant communications system with one or more non-standards compliant communications system.

Communications systems are generally dynamic. Not only do their logical topologies change dynamically, new physical devices are added, while existing physical devices are moved or removed. The dynamic nature of communications systems makes maintaining a real-time list of network devices, along with one or more attributes that can be used to identify them (e.g., Internet Protocol (IP) addresses, port information, and the like) challenging. Additionally, new applications, modules, or versions of software (including both operating systems and software applications) may be downloaded, and hardware (e.g., RAM, CPUs, hard drives, solid state memories, network cards, and the like) may be changed.

Network discovery may be scheduled to occur at pre-defined times and/or intervals; it may also be performed on an as-needed basis. Since a typical communications system is large, such network discovery operations usually involve a large amount of processing. Typically, network discovery is collector-based and multiple scanning methods (such as, ping sweeps, port scans, simple network management protocol (SNMP) scans searching for different types of SNMP attributes, and the like) may be utilized.

However, applications for network inventory vary. High end applications utilize network discovery and generate open systems interconnection (OSI) level 1, 2, and 3 topological views of the communications system. Higher end applications include network devices, operating systems, high-level application data (e.g., CPU, disk, memory uptime, utilization, and the like). Once the views of the communications systems are generated, changes to the communications system can be quickly detected.

There may be dependencies between the type of data being discovered and/or inventoried and the type of protocols being used to discover and/or report the data. There may be an important dependency between the type of protocol used to collect the data and the type of data to be collected. As an example, if SNMP is used, then there are various management information base (MIB) objects defined that differentiate between hosts and “devices that forward datagrams” (e.g., a device that acts as a router). It is noted that this does not mean that the device is a router; for example, a layer three switch may also act as a router. More importantly, (a) other protocols may not have this capability defined, (b) other protocols may define a set of capabilities that have more or less functionality than this capability, and/or (c) this differentiation may not be enough to accurately classify a particular network entity.

As another example, the type of ManageableEntity may have specific attributes and/or behavior that dictate the need to use a specific type of protocol. For example, a port that is defined as a bridge sends bridge packet data units (BPDUs), whereas the same port may send different PDUs for communication at different layers. This is made more complex because higher layers, such as layers 5-7, do not refer to a PDU per se, but rather to the actual data (or transfer of the data).

As yet another example, the selection of the type of data to collect affects the type of protocol to use when looking for specific types of neighbors for a specific entity type. For example, if discovery is performed on a port whose role is a “Provider Edge” role, then in some circumstances, that port can connect to other ports with a role of “Customer Edge”, “Provider Edge”, or “Provider Core”. While in other circumstances, it may be limited to only looking for ports whose role is “Provider Edge”. Furthermore, if that same port was using multiprotocol label switching (MPLS), then it could also look for Label Switching Routers as well as ingress, egress, and other types of MPLS routers.

As yet another example, the type of attributes that an entity has when looking for specific types of functionality that a device or port has can also dictate the use of a specific protocol to use, because the data to be retrieved may be very specific. For example, a device may be interested in determining if a node supports neighbor discovery, such as active reservation protocol (ARP) or neighbor discovery protocol (NDP), capability, or how a node obtains its address(es) (e.g., by using bootstrap protocol (BOOTP) or dynamic host configuration protocol (DHCP)).

The above discusses several types of dependencies between protocols used to collect data and the data to be collected. There may also be relationships between the data to be collected and the type(s) of pre- and post-processing operations that should be performed on the collected data to make said data more useful to the management system, and which data (if any) should be stored in what type of repository at what step in the above operations, e.g., pre-processing or post-processing. The set of these dependencies and relationships require coordination and optimization of computational and storage resources. The example embodiments presented herein may use the knowledge represented in an information model to define the characteristics and behavior of model elements that represent ManageableEntities, as well as to represent different types of decision-making and reasoning processes and rules to govern the application of said processes.

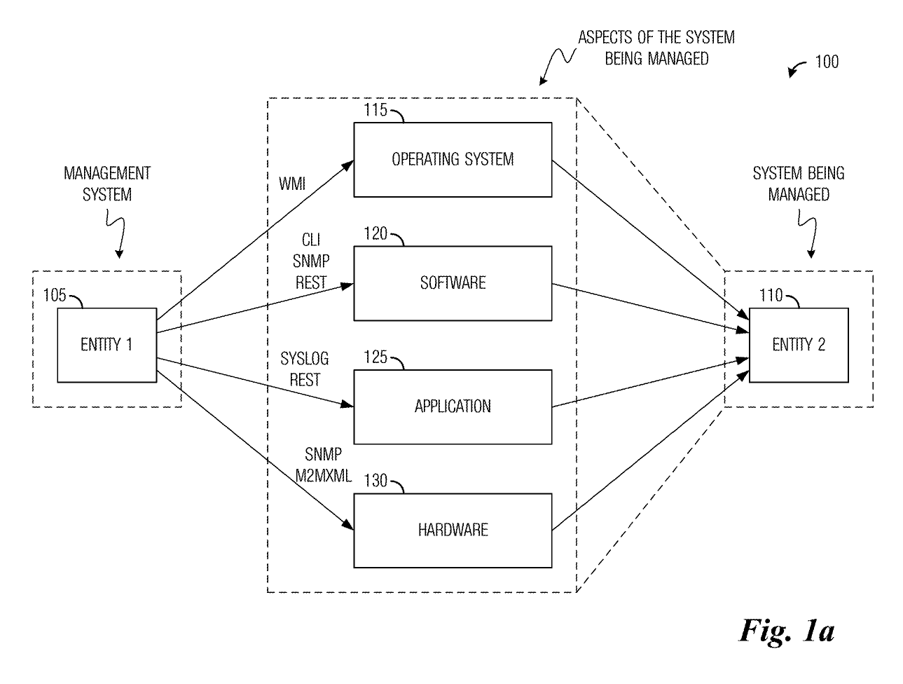

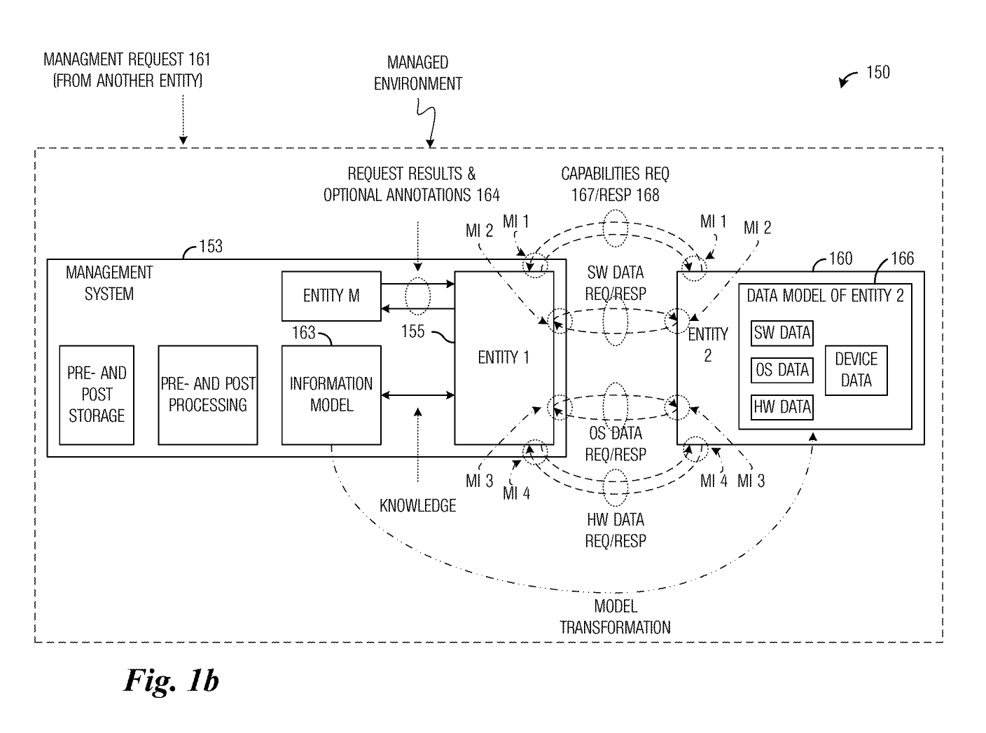

FIG. 1a illustrates a managed environment 100, in which a first entity 105 is managing a second entity 110. The first entity is part of a management system, and the second entity is part of a system being managed. It is noted that without loss of generality, the term managing (or management) may refer to both monitoring and/or configuring. It is also noted that although shown as single entities, first entity 105 and second entity 110 may each represent multiple entities.

First entity 105 may manage as well as interact with second entity 110 through one or more levels. As an example, management may occur at an operating system level 115, where first entity 105 may utilize a protocol, such as web management interface (WMI), to manage second entity 110. Management may also occur at a software level 120, where first entity 105 may utilize a protocol, such as Telnet, SNMP, representational state transfer (REST), and the like, to issue command line interface (CLI), SNMP, or other types of commands, respectively, to manage second entity 110. Management may also occur at an application level 125, where first entity 105 may utilize a protocol, such as system log (SYSLOG), REST, and the like, to manage second entity 110. Management may also occur at a hardware level 130, where first entity 105 may utilize a protocol, such as SNMP, machine to machine extensible markup language (M2MXML), and the like, to manage second entity 110. Entities 115, 120, 125, and 130 each represent different aspects of the system being managed; the management system may obtain their current state, values, and/or configuration information from second entity 110, and may then change one or more of these aspects (i.e., entities 115, 120, 125, and 130) as part of its management processes.

The example embodiments presented herein uses an object-oriented information model to define managed entities (e.g., entities in a communications system) of interest. The discussion presented herein will make use of the following terminology:
An information model is an abstraction and representation of the entities in a managed environment. This includes definition of their attributes, operations and relationships. It is independent of any specific type of repository, software usage, or access protocol;
A data model is a concrete implementation of an information model in terms appropriate to a specific type of repository that uses a specific access protocol or protocols. It includes data structures, operations, and rules that define how the data is stored, accessed and manipulated;
A model mapping is a translation from one type of model to another type of model. Model mapping changes the representation and/or level of abstraction used in one model to another representation and/or level of abstraction in another model;
The term model element is a generic term that defines abstractions that can be represented in an information model. Examples include class, attribute, different types of relationships (e.g., associations, aggregations, and compositions), and other constructs;
A PolicyRule is an intelligent container. It contains data that define how the PolicyRule is used in a managed environment as well as a specification of behavior that dictates how the managed entities that it applies to will interact. The contained data is of four types: (1) data and metadata that define the semantics and behavior of the policy rule and the behavior that it imposes on the rest of the system, (2) a set of events that can be used to trigger the evaluation of the condition clause of a policy rule, (3) an aggregated set of policy conditions that, if true, permit the execution of one or more policy actions, and (4) an aggregated set of policy actions that perform one or more operations (e.g., change the configuration of, or collect data from, a given device);
A ManageableEntity is defined as any entity of interest in a managed environment that can perform and/or respond to management functions. Examples of a ManageableEntity include devices (e.g., routers, switches, host computers), entities that are part of a device (e.g., physical ports and logical device interfaces), as well as protocols, applications, servers, and services—in short, anything that can respond to management requests;
A Behavior or Behaviors is represented as a set of model elements that capture four different aspects of managing behavior: (1) a means to uniquely identify the ManageableEntity as a function of context; (2) to manage the functions and roles that a ManageableEntity can produce and consume a set of mechanisms based on different types of policy rules and state automata that execute in a management domain (and between federated management domains), (3) the ability to orchestrate and/or choreograph the behavior of one or more ManageableEntities (orchestration defines the behavior of a set of ManageableEntities from their own point-of-view, while choreography defines the behavior of a set of ManageableEntities from the point-of-view of other ManageableEntities), and (4) the definition of a set of roles (human and machine) that can interact with, use, and/or operate on the ManageableEntity;
Network-based data collection may be defined as the ability to efficiently collect information regarding ManageableEntities accessible in a network. This specifically refers to ManageableEntities at the “parent” as well as “child” levels (e.g., a device and its ports, or an application and the services that it provides);
Agent-based data collection involves using dedicated software running locally on a managed device as part of the management infrastructure; the agent-based software is solely devoted to management (which includes, but may not be limited to, data collection);
Agentless data collection involves collecting data from ManageableEntities without installing any new software on the device that hosts the ManageableEntities on them; the key difference between it and agent-based data collection is that agentless data collection does not involve installing any new software on any machines to be monitored; and
Data collection management approach is defined as the combination of a set of data models, protocols, and software that enable collected data to be analyzed, processed, and understood, so that the ManageableEntities that produced the collected data can be monitored and managed.

An example embodiment uses DEN-ng, or another information model that has similar characteristics, as the information model. In this case, model elements, PolicyRules, ManageableEntities, Behavior, and metadata are both defined as an inherent part of the DEN-ng information model.

FIG. 1b illustrates an example of a managed environment 150, consisting of a management system 153 and a second entity 160. A first entity 155 is a part of management system 153, and is managing second entity 160, which is a part of managed environment 150. With no loss of generality, the management system 153 may be part of or separate from the managed environment 150.

Managed environment 150 may receive a management request 161 by an entity that is not contained in the managed environment. Management request 161 will be directed to first entity 155, which then produces a set of commands to collect data from second entity 160. First entity 155 may consult an information model 163 to determine if any information about second entity 160 is available. Information model 163 defines archetypal information and behavior, in an object-oriented form, that may be thought of as a set of model elements that represent the functionality and behavior of second entity 160. Annotations 164 may also be defined and are used to describe the time, version, and other metadata that define the appropriate set of objects that represent the appropriate instance of second entity 160, and whether such objects have already been defined in one or more data models 166. If insufficient knowledge exists about second entity 160 (e.g., what version of which operating system is it currently running), then first entity 155 may need to exchange one or more messages, e.g., capabilities request 167 and capabilities response 168 messages, with second entity 160 to determine the functionality and behavior that second entity 160 supports. The capabilities request 167 and capabilities response 168 messages may be based on the knowledge contained in information model 163. The exchange of any data, including those shown in this exchange, may comprise two uni-directional exchanges, one for requesting data, and one for returning the data requested.

First entity 165 may examine the data that is requested to be collected from management request 161, and compares this request with the capabilities of second entity 160 in order to determine how best to obtain the data requested. A problem is that many elements in the data collection process may be dependent on each other. As an example, the type of protocol used can affect which data can be collected, and at what frequency, granularity, and other factors. These and other dependencies are modeled using Information Model 163. As an example, the exchange of capabilities request 167 and capabilities response 168 messages define which protocols are supported by both first entity 155 and second entity 160. Using the protocols, first entity 155 may then issue a set of data requests to appropriate ManageableEntities that comprise second entity 160, where each ManageableEntity in second entity 160 may use the same or a separate protocol.

As an illustrative example, a Hypertext Transfer Protocol (Secure) (HTTP(S)) capability request may be sent by first entity 155 to second entity 160 to provide various performance metrics, such as the time since its last reboot, the amount of memory currently being used, and so forth. Such metrics may typically be supported by multiple protocols (e.g., Simple Network Management Protocol (SNMP), System Log (Syslog), Command Line Interface (CLI), and others); however, each protocol may use a different set of resources and have a different accuracy. It is possible that first entity 155, through use of information model 163, will first optimize the request for data from second entity 160 by optimizing the use of the same protocol, where possible, to get the most accurate data possible. The set of ManageableEntities that comprise second entity 160 may be defined by data model 166 of second entity 160 and data model 166 may be derived from information model 163.

Hence, first entity 155 may use a particular protocol with a specific management interface to request specific data from second entity 160 (e.g., WMI for Operating System data, CLI for software, SNMP for hardware, and the like). It is noted that a protocol may be used to support one or more types of data, and that a particular type of data may require multiple protocols to obtain all of the information that constitute a particular type of data (for example, this is illustrated in FIG. 1a by using the combination of CLI, SNMP, and REST to retrieve all of the Software information from second entity 110). These requests then query the appropriate ManageableEntities that are part of second entity 160. Replies to the query or queries may come back through the same management interface of second entity 160 that the requests were received. First entity 155 may then read the collected data, optionally process and store it, and then either notify a requestor of the data that the data is ready or directly send the data to the requestor.

FIG. 2a illustrates a relationship and mapping between an information model 205 and a set of data models. Conceptually, information model 205 provides a view of the inherent connectedness between data and a managed communications system. Information model 205 enables information, knowledge, wisdom, and the relations, patterns, and principles that they represent to be modeled in a technology-neutral manner. In contrast, data models, such as data models 210-212 and data models 220-222, may be considered to be instances of information model 205. The data models may be derived from information model 205 and can be related to each other, since they share the concepts that are defined in the information model. A difference between an information model and a data model that define the same concepts is the realization of those concepts using technologies, languages, and/or protocols. In general, the information model does not use any platform-, language-, and/or protocol-specific definitions. On the other hand, data models are typically tightly bound to at least one, and usually all, of these three features (platform, language, and protocol).

There may be several types of data models. A first data model type may be a technology-specific but vendor-neutral instantiation of information model 205. As an example, data models 210-212 are technology-specific but vendor-neutral instantiations of information model 205, and could represent concepts using a directory, a relational database, and a flat file. A second data model type is a technology-specific and vendor-specific instantiation of information model 205. As an example, data models 220-222 are technology-specific and vendor specific instantiations of information model 205 as well as data model 211.

FIG. 2b illustrates a relationship 250 between the semantics (i.e., understanding) of data and connectedness (i.e., how those data relate to each other and to the current or future context of the system being managed) for data. Typically, raw data becomes information when relationships between the raw data are known. Once patterns are known, information may become knowledge, which in turn, becomes wisdom once principles are known. The information model may be used to define a set of methods that may be used to transform data into information, knowledge, and wisdom.

In general, an information model may:
contain different types of knowledge that can be collectively organized according to different parameters (e.g., policy, context, and the like); these parameters can be used as context-defined filters to interpret the collected data;
help to organize relationships between data inferable from collected data with sufficient supporting data;
organize knowledge by views applicable to a particular constituency or set of constituencies, rather than just a parameter(s);
define patterns that can be used to define how to collect, aggregate, filter, match, correlate, and perform other processing operations on network data; the operations are possible due to object-oriented class and relationship definitions present in the information model;
enable different types of protocols to be used that can reveal different types of data about a single network entity or a set of network entities, as well as their mutual constraints;
be independent of technology, platform, and protocol; enabling the information model to be used to support multiple data models through a set of mappings, making it superior to starting with a particular data model since it abstracts the specification of the network objects and their relationships from how they are to be collected and the implementation of the collection;
abstract both the specification of the network objects and their relationships from additional enhancements, such as implementation of metadata, reasoning using first order logic, and additional mechanisms;
enable the collection process to be separated from additional post-collection processing tasks for verifying further behavior that a given network entity has; and
enable behavior to be defined as a set of concepts, contained in the information model, that define the syntax and static semantics of behavior (static semantics refers to those aspects of behavior that may be defined at design time that affect the state of a ManageableEntity), which may be performed by a set of concepts that can also be defined in the information model, including but not limited to policy rules and state automata.

A benefit of using the information model is that it provides a self-describing set of mechanisms that define how knowledge can be used to describe the semantics of characteristics and behavior of a ManageableEntity, including its attributes and relationships.

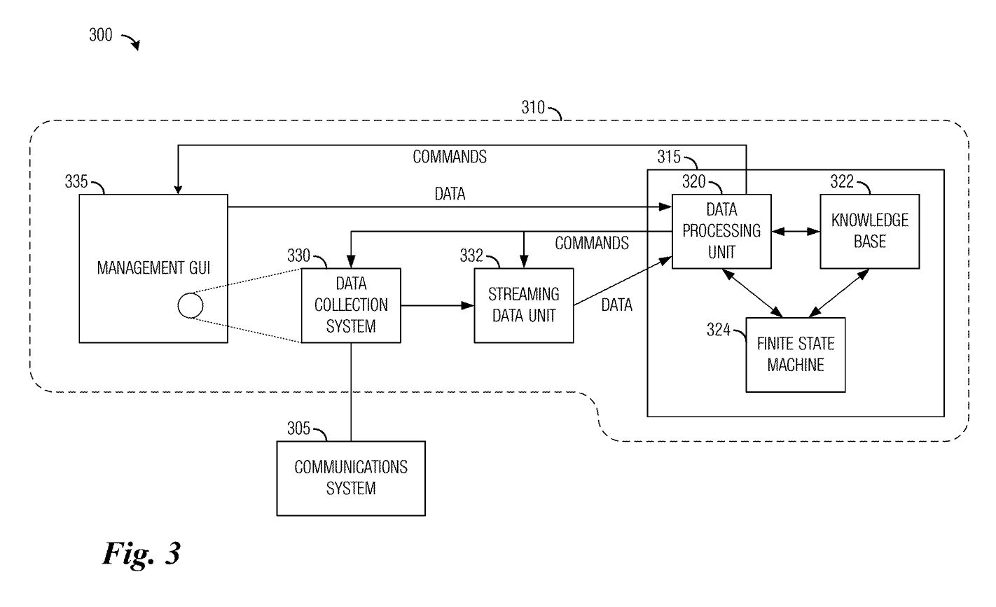

FIG. 3 illustrates an example system 300 including a communications system with an information model based management system. System 300 includes a communications system 305 and a management system 310 that may be used to manage communications system 305. Management system 310 includes a management entity 315 that may process data collected from communications system 305 using data processing unit 320. Management system 310 provides a knowledge base 322 that may enable management system 310 to determine which data to collect, how to collect it, and may also include instructions for how to analyze and process the data collected from communications system 305, and the like. Knowledge base 322 may implement an information model of communications system 305, as well as one or more data models thereof. A finite state machine 324 may be used to control the operation of management entity 315.

Management system 310 may also include a data collection system 330 to collect data from entities in communications system 305. Data collection system 330 may make use of one or more protocols as specified by management entity 315 to collect data from communications system 305. Data collection system 330 may stream data using a streaming data unit 332 to management entity 315. The streamed data may be delivered out of order, fragmented, with some data missing, and the like. Some data may be retrieved using specific protocols under specific conditions. A management graphical user interface (GUI) 335 may allow users, such as operators, managers, and the like, to interact with management entity 315, as well as communications system 305.

Dependency Analysis

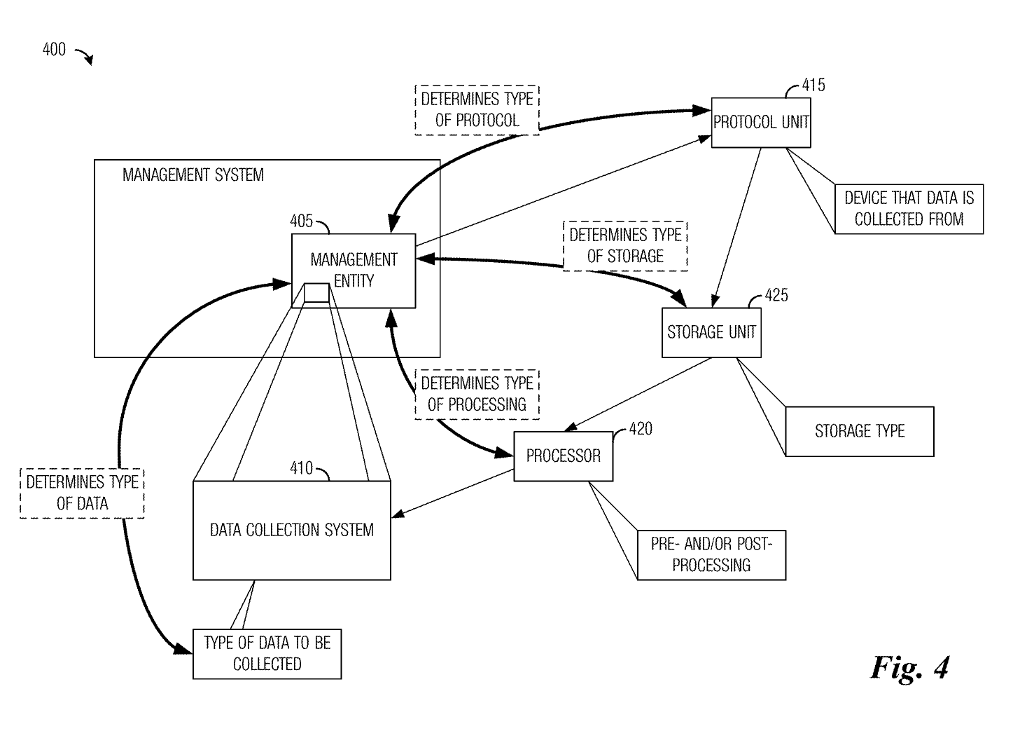

FIG. 4 illustrates an example management system 400 with detail provided for the salient functions of a portion of the management system. Management system 400 includes a management entity 405 that may determine the type of data to be collected (via a data collection system 410), determine the type of protocol used to collect the data (via a protocol unit 415), determine the type of processing (e.g., pre-processing occurring during the collection of the data and/or post-processing occurring after the collection of the data has been completed) to be provided to the collected data (via a processor 420), and determine a type of storage (e.g., pre-storage, which is temporary storage that is used during the collection of the data, and/or post-storage, which is temporary and/or permanent storage that is used after the collection of the data has been completed) to be used to store the collected data (via a storage unit 425). As discussed previously, an information model of a communications system may be used by management system 400, specifically, management entity 405, to determine the type of data, the type of protocol, the type of processing, and the type of storage required for a given data collection task.

Using an information model of a communications system allows for a common set of model elements that can be used to define interrelated semantics that exist between the type of data to be collected, the type of protocols used to collect the data, the type of pre-processing and post-processing operations that are to be performed on the collected data, which data (if any) should be stored in what type of data repository, and the like. Each of these interrelated semantics may represent dependencies between these fundamental portions of the data collection process. Furthermore, each is uni-directional. For example, the type of data that is to be collected restricts the type of protocol that can be used, since the type of protocol may need to satisfy a number of requirements, including: (1) the protocol may need to be able to transport the data reliably (and possibly securely), meaning that the accuracy of each datum, as well as the entire data set, should not be altered), and (2) the protocol may need to be able to support appropriate operations (e.g., create, read, update, delete, and the like) on the data. Similarly, the protocol constrains the type of data, in that the protocol (1) may need to be able to support the data structures that are used by the data to be collected, and (2) the protocol may need to be semantically compatible with the use of the data. For example, while directories can theoretically store and retrieve any type of data structure, their protocol (e.g., the Lightweight Directory Access Protocol (LDAP) or even its stronger and more robust version, X.500 (a set of standards defining directory services by the ITU-T)) was designed primarily to be used with simple textual search applications. This may place a fundamental limitation on how data can be searched, created, edited, and retrieved in a directory.

If the above dependencies are understood and satisfied, then a unified platform may be built, i.e., a platform that is independent of the technology used to implement the type of protocol, the type of ManageableEntity, the type of data to be collected, the types of pre-processing and post-processing operations to be performed, the types of storage operations and storage to be performed, and the like. In particular, the unified platform allows for:
a set of reusable abstractions—since protocols, data, pre-processing functions, post-processing functions, data repositories, and storage operations may all be represented as model elements, all exist as reusable objects in the management system;
a set of patterns to create the reusable abstractions as provided by the information model, which may simplify the resulting design and implementation;
a second set of patterns that describe predicted and/or expected relationships and behavior between ManageableEntities, which may further simplify the resulting design and implementation;
an extensible set of mechanisms to identify a ManageableEntity, as well as its attributes and behavior since a ManageableEntity may be identified by a set of attributes, relationships, metadata, behavior, and/or structure;
a second set of extensible mechanisms to identify a ManageableEntity, as well as its attributes and behavior since a ManageableEntity may be identified by a set of patterns of data and relationships that characterize its behavior;
the ability to direct the collection of data based on intrinsic and extrinsic model elements that represent the ManageableEntity or set of ManageableEntities that data is being collected for;
the ability to determine whether any additional data should be collected from ManageableEntities that have already been visited (allowed by the virtue of comparing the MangeableEntity data collected to the representation of the ManageableEntity in the information model and determining if data is missing);
the ability to define which collected data should be stored in which type of data repository (if any) after which type of pre-processing operation and/or post-processing operation (if any) are performed; and
the ability to define which of the above discussed features (if any) is affected by which types of changes in the context of the environment.

High-Level Overview of the Management System for Collecting Data

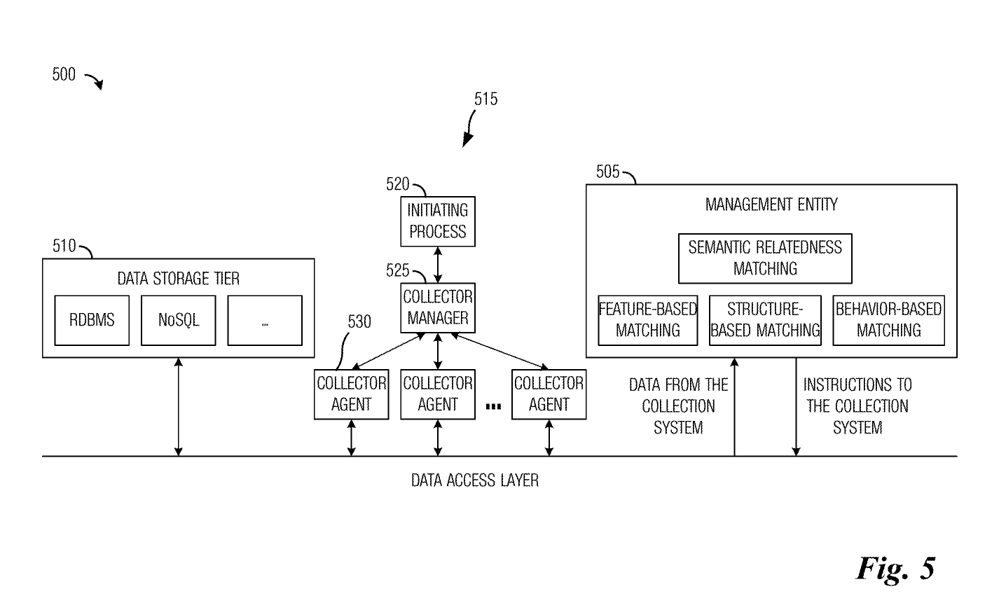

FIG. 5 illustrates a detailed view of components of an example management system 500. As shown in FIG. 5, management system 500 includes a management entity 505, a data storage tier 510, and a detailed view of a data collection system 515. Management entity 505 includes a plurality of class identification units that identify classes of objects, e.g., a ManageableEntity, using a variety of matching techniques, including name recognition, identify recognition, feature-based matching, structure-based matching, behavior-based matching, semantic relatedness matching, and the like. Data storage tier 510 may provide storage and/or management for the collected data. Examples of collected data storage management include a relational database management system (RDBMS), not only structured query language (NoSQL) system, and the like.

Data collection system 515 may include an initiating process 520 that controls the collection of the data, including starting and/or stopping the collection of the data. Also included may be a collector manager 525 that is responsible for collecting the data provided by a plurality of collector agents (such as collector agent 530). Since the data provided by the plurality of collector agents may be fragmented, out of order, lost, and the like, collector manager 525 may unfragment (or equivalently, defragment), reorder, correct, and/or recover the collected data. The collected data may be provided to management entity 505. Data collection system 515 may receive instructions on the data to be collected from management entity 505.

The data collected, i.e., the data collected from the ManageableEntity or set of ManageableEntities, may be used to discover if new capabilities have been added to an existing ManageableEntity (e.g., a new card was added having additional ports), or if new ManageableEntities have been added to the communications system (e.g., a new Virtual LAN (VLAN) was created). These two examples correspond to the management system 500 being able to detect the addition of new physical and logical (or virtual) capabilities of the system being managed. Similarly, data collection may be used to discover if existing ManageableEntities and/or their capabilities have been removed from the system or are no longer functioning properly. The data collected may also be used for collecting metrics usable in calculating and/or estimating a performance level of a ManageableEntity. The metrics may also be used to generate alarms and/or faults, optimize the performance of the ManageableEntity, perform maintenance operations, execute additional management operations, and the like. These operations, commonly referred to as operational and/or management operations, may be more complex since different types of ManageableEntities have different types of characteristics and behavior. Furthermore, a single instance of a ManageableEntity may exhibit different behavior in different contexts. Therefore, a robust mechanism may be needed to relate the impact of a context on the collection of the data.

Data collection may also be used to query existing parent and/or child nodes to determine additional information about each node. Generally, given a set of known ManageableEntities (referred to herein as parent nodes), each parent node may have a set of child ManageableEntities (e.g., ports of a router, switch, or host computer, or services of an application). As an example, the type of node will often determine the type(s) of ManageableEntity that may be related to that node, as well as protocol, media layer, and other physical and/or logical characteristics that form semantics of those relationships. Examples include port bonding and link aggregation (which are a function of the type of port, type of media, and the type of protocol being used). Different types of VLANs and Virtual Private Networks (VPNs) have similar semantics. Similarly, services may also be found from parent nodes and/or child nodes using several different protocols (e.g., simple service discovery protocol (SSDP), service location protocol (SLP), universal plug and play (UPnP), and the like). These protocols have different applications, and hence different semantics. Hence, the information model provides a single source for representing different types of ManageableEntities, and their relationships, using a common set of model elements with a common set of semantics.

Usually, data collected from ManageableEntities attached to one or more communications systems will be intermingled, making it difficult to associate data with a specific ManageableEntity to which it belongs. This may be exacerbated by change, e.g., ManageableEntities can join or leave communications systems without the management system being informed. Furthermore, ManageableEntities may be changed. As an example, the configuration of a ManageableEntity's configuration may be changed, which alters the functionality that the ManageableEntity provides (and therefore, the type of data that it sends and receives, as well as the type of data used to configure it). The information model of the communications system provides the knowledge needed to recognize one or more capabilities of a ManageableEntity or a set of ManageableEntities. Management of heterogeneous entities may therefore be normalized by matching common aspects of different capabilities of each of the different ManageableEntities. Once a set of common capabilities is determined, further processing may continue (if needed) across applicable sets of ManageableEntities.

An information model may be used to optimize the data collection process or set of processes for obtaining data from all or a subset of ManageableEntities. The optimization may be based on optimization factors, including the nature of the data to be collected, the type of ManageableEntities involved, the type of protocols that are used, the context of the communications system, needs of users and/or applications of the collected data, and the like. Optimizations may include determining which users and/or applications need the same data and optimizing the collection of the data so that the data is queried as few times as possible; use the same protocol and optimizing the collection of the data so that the number of protocol connections is minimized; and use the same commands (e.g., vendor-specific CLI, vendor neutral scripting languages, and the like) to query different attributes of the same or different ManageableEntities and optimizing the collection of the data (optionally with different attributes being filtered differently).

The behavior of a ManageableEntity A may be defined as a set of intrinsic attributes and/or relationships that involve ManageableEntity A, and/or a set of extrinsic classes, attributes, and/or relationships between the ManageableEntity A and a set of model elements that represent one or more ManageableEntities B₁ . . . Bₙ. It is noted that the definition also holds when the single ManageableEntity A is replaced with a set of ManageableEntities A₁ . . . Aₘ. The use of an information model may enable behavior to be statically defined and managed through a set of mechanisms that are themselves expressed in the information model (e.g., by using a dedicated set of model elements) such as policy rules and/or state automata. It may also be possible to dynamically define behavior, as well as enable changes in behavior.

The use of the information model may allow the management entity to be independent of technology-specific implementation. This is applicable to the protocols used as well as the type of data to be collected, the type of ManageableEntity that is the target for the data collection operations (e.g., storage device vs. network device vs. server vs. application), how that data is collected, the type of pre- and post-processing done on the collected data, the type of storage used for the collected data, how the ManageableEntities themselves are represented, and the like. Furthermore, the management entity is independent of data collection mechanism, e.g., collection agents, agentless collection, or a combination thereof.

In general, communications systems generate great amounts of data. Therefore, management systems collect massive amounts of network data. Abstractions of the network data typically do not make it any easier for users to find different types of network data. Additionally, communications systems can change without warning, and different changes affect different entities in often unpredictable ways. To further compound the situation, different equipment vendors utilize different names to refer to the same type of network data, as well as use different functions that require different protocols. There may simply be too many variations to provide a single consistent interface for each different category. Therefore, there is a need for a system and method for a model-based search and retrieval of networked data.

As an illustrative example, an entity being managed is very complex. The entity may not be a single object; instead it may be made up of many objects. Each of the objects may be managed individually or collectively. Furthermore, the behavior of an entity may change when it is grouped with other objects. Data models may be used to represent the communications system. However, the use of data models implies that the communications system is dependent on data structures and protocols used by the communications system and not how the entities and/or objects actually behave in actual use.

According to an example embodiment, a model driven approach is used to find a set of managed objects. Knowledge present in an information model of the communications system may be used to identify objects specified (directly or indirectly) in a query. The knowledge may be augmented with a data model. An example embodiment enables ManageableEntities to be found that do not explicitly map to network data being searched for. The managed objects may be found using their characteristics and/or behavior; this enables ManageableEntities to be found without specific use of names or other identifying data. As an illustrative example, symptoms may be used to identify objects instead of part number or serial number. An example embodiment maps different parts of speech used in the query to be mapped to different model elements. Note that model elements may correspond to a ManageableEntity, a set of ManageableEntities, or simply data from one or more ManageableEntities.

An example embodiment enables semantic searches to also be performed. In this type of search, data from ManageableEntities, as well as ManageableEntities, are found based on the meaning of the search. This approach uses the information model as a lexicon, so that model elements that have the same or similar meaning can be found.

An example process may include: receiving a query; removing irrelevant words and phrases from the query; remove capitalization, function words, and the like; and applying the processed query.

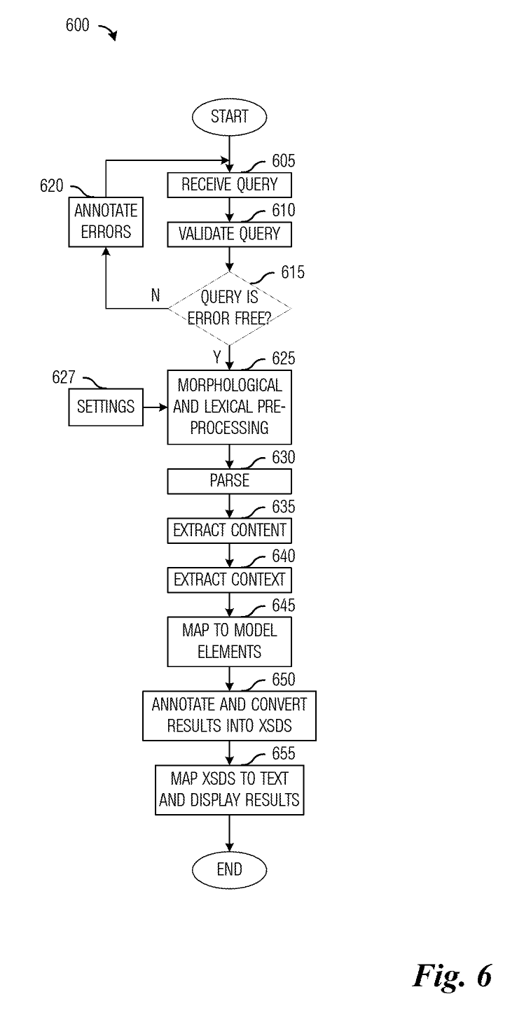

FIG. 6 illustrates a flow diagram of example operations 600 occurring in processing a query of network data. Operations 600 may be indicative of operations occurring in a query processing device, such as a management system, a management entity, and the like, as the query processing device processes a query of network data.

Operations 600 may begin with the query processing device receiving a query of network data (block 605). The query may be in the form of input from a user of the query processing system, an application executing in conjunction with the query processing device, another query processing device, an external query processing device, another instantiation of the query processing device (such as in a distributed query processing device), and the like.

The query processing device may validate the query (block 610). Validating the query may help to ensure validity of the query, detect errors in the query, and the like. A valid query will map to at least one model element. The query processing device may perform a check to determine if the query is error free (block 615). If the query is not error free, the query processing device may annotate errors in the query (block 620) and return to block 605 to receive another query. The query processing device may, after annotating errors in the query, inform a source of the query regarding the errors and possibly prompt for another query.

The query processing device may perform morphological and lexical pre-processing of the query (block 625). The morphological and lexical pre-processing may help simplify subsequent parsing and decision-making operations. Examples of morphological and lexical pre-processing include removal of stop words, removal of punctuation, removal of capitalization, removal of function words, stemming, and the like. As an example, by performing morphological normalization operations, a single canonical word form may be used to group words that appear different into the same morphological family. As yet another example, morphological and lexical preprocessing may identify additional dependencies between elements of the query that were not explicitly mentioned as part of the query. The morphological and lexical pre-processing may receive settings (block 627) as input to assist in the pre-processing.

The query processing device may parse the query (block 630). Parsing the query may also include the production of part of speech (PoS) tokens, which are used to help guide further processing. The query processing device may extract content tokens from the parsed query (block 635). The content tokens include information that the user wants to retrieve translated into a form that permits ready definition of dependencies between different components. The query processing device my extract context tokens from the parsed query (block 640). The context tokens collectively represent both extrinsic metadata that are known by the user and/or the management entity as well as intrinsic metadata that only the management entity knows about.

The query processing device may map the tokens to model elements (block 645). A detailed discussion of the mapping of the tokens to the model elements is provided below. The query processing device may annotate and convert results of the mapping of the tokens to the model elements into extensible markup language (XML) schema definition(s) (XSD) file(s) (block 650). The query processing device may map the XSD file(s) to text and display the results (block 655).

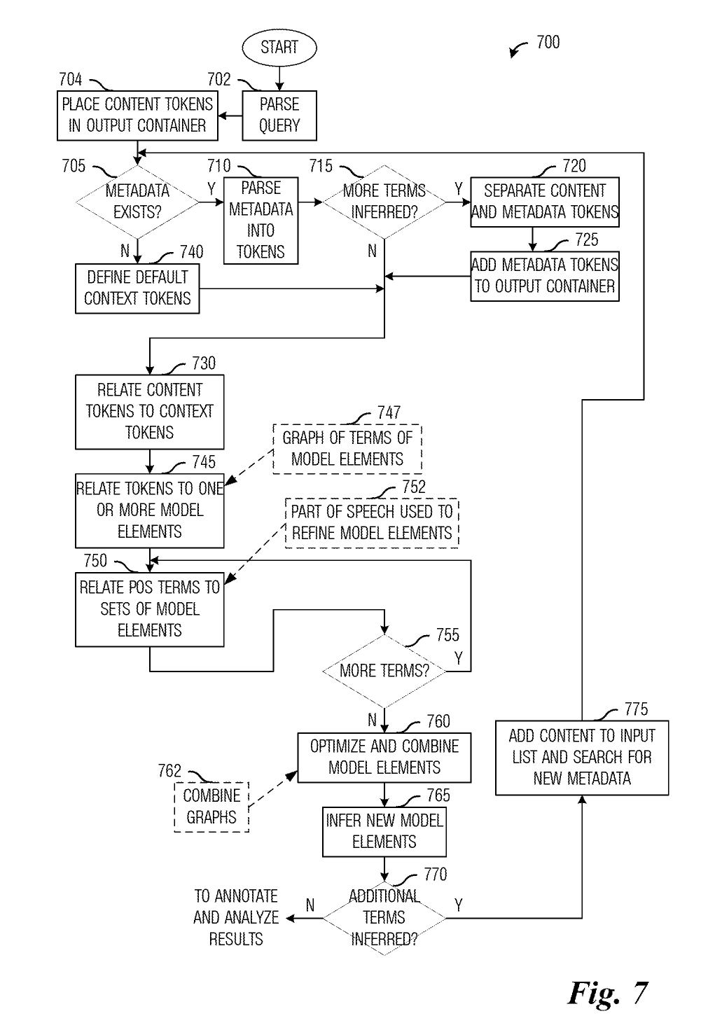

FIG. 7 illustrates a flow diagram of example operations 700 occurring in mapping tokens to model elements. Operations 700 may be indicative of operations occurring in a query processing device, such as a management system, a management entity, and the like, as the query processing device maps tokens to model elements.

Operations 700 may begin with the query processing device parsing the query (block 702), which extracts a first set of content tokens from the query. The content tokens are placed in an output container (block 704). The query processing device may then perform a check to determine if metadata exists (block 705). The metadata may be present in the query and may be may be descriptive and/or prescriptive in nature. The metadata may be defined explicitly (e.g., as part of the query) or implicitly (e.g., implied from the query). An example embodiment uses metadata to better understand the intent of the query. Without metadata, the query processing device is limited to using just the syntactical structure of the query. With metadata, the query processing device may better understand the context of the query, and thus, be able to find model elements that are related to why the query is being issued (instead of just relying on the syntax used). In either case, if metadata exists, the query processing device may parse the metadata into a second set of metadata tokens (block 710). The query processing device may perform a check to determine if more content terms have been inferred from the metadata by comparing the content and metadata tokens (block 715). If more terms have been inferred, the query processing device may separate the first set of content tokens from the second set of metadata tokens (block 720), as well as add the metadata tokens to either the same container that holds the content tokens, or a different container (block 725). If metadata does not exist, the query processing device may define default context tokens and add them to an output container (block 740).

The query processing device may define relationships between content tokens and context tokens (block 730). This step adjusts the content of the query to reflect the context of the query being issued. The query processing device may also relate the combination of content and context tokens to one or more model elements (block 745). An example embodiment represents the combination of content and context tokens as a set of graphs, and then relates the set of graphs to one or more model elements, forming an output set of graphs (block 747). A detailed discussion of the relating of terms in a content group to one or more model elements is provided below. The query processing device may also relate appropriate parts of speech (POS) tokens obtained from the initial parsing of the query to sets of model elements (block 750). An example embodiment may use the POS tokens to refine the model elements (block 752). For example, the POS tokens may imply that additional model elements are present and possibly related to the existing model elements that were found from step 745.

An example embodiment iterates through each model element that was produced from the combination of content and context tokens to determine if one or more POS tokens provides additional information about the nature of the query (block 755). An example embodiment represents both the POS tokens and the model elements as graphs, since this enables all types of model elements (e.g., classes, attributes, relationships, and constraints) to be efficiently matched using a variety of well-known graph algorithms. If there are more terms produced by the POS tokens, the query processing device may return to block 750 to continue relating appropriate POS terms to sets of model elements. If there are no more terms, the query processing device may combine and optimize the model elements (block 760). This may reuse one of the existing containers, or be placed in a third container. An example implementation performs the combining and optimizing of the model elements by utilizing graph algorithms that specify how the model elements may be combined (block 762). For example, a variety of graph traversal algorithms may be used to visit all nodes in each graph, and different types of coloring, sorting, transitive closure, and other types of graph algorithms can be used to find model elements corresponding to content and context terms. The query processing device may infer new model elements from the combined and optimized model elements (block 765).

The query processing device may perform a check to determine if there are additional terms to infer (block 770) due to the combination and optimization of model elements (block 765). If there are additional terms to infer, the query processing device may add content terms to an input list and search for new metadata (block 775). The query processing device may return to block 705 to determine if new metadata is added from block 775. If there are no more additional terms to infer, the query processing device may annotate and analyze the results, e.g., block 650 of FIG. 6.

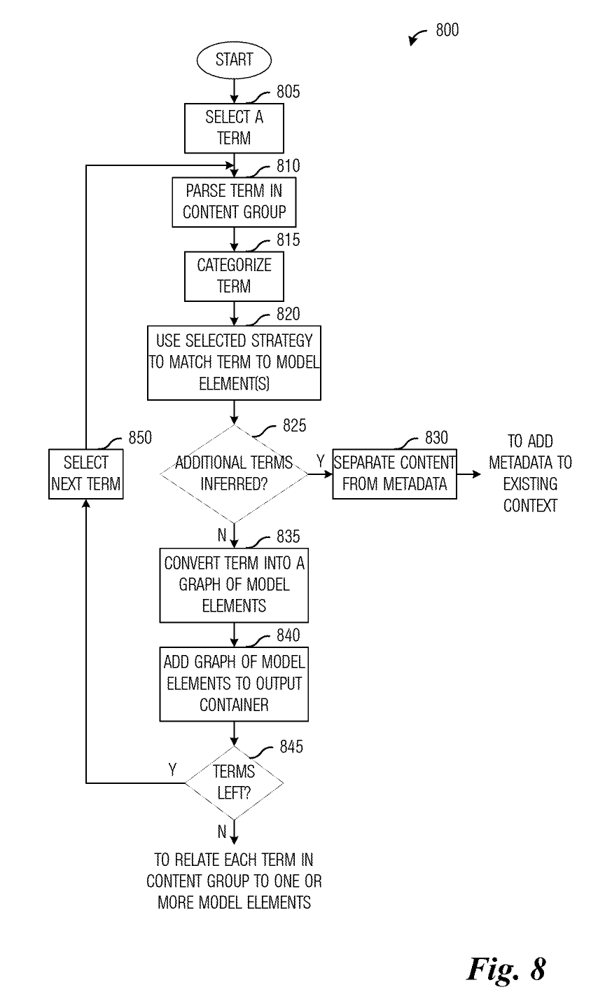

FIG. 8 illustrates a flow diagram of example operations 800 occurring in relating of terms to one or more model elements. Operations 800 may be indicative of operations occurring in a query processing device, such as a management system, a management entity, and the like, as the query processing device relates terms to one or more model elements.

Operations 800 may begin with the query processing device selecting a term of a content group (block 805). The query processing device may parse the term in the content group (block 810) and categorize the term (block 815). The query processing device may use a selected strategy to match the term to a model element(s) (block 820). For example, the name of the content term may be represented as a single canonical word form and then used to find a model element of the same name. This would be the case if, for example, the query input was constrained to offer choices of terms that were directly related to model elements. More often, however, additional linguistic processing will be required. An example embodiment will use various types of linguistic processing, such as Feature-based, Structure-based, Behavior-based, and/or Semantic Relatedness Matching, to match a content term to one or more model elements. The query processing device may perform a check to determine if there is an additional term(s) that have been inferred during the processing of the selected term (block 825).

If there is an additional term(s), the query processing device may separate the term from metadata (block 830) and the query processing device may add the metadata to the existing context, such as in block 725 of FIG. 7. If there are no more additional terms, the query processing device may convert the selected term to a graph of model elements (block 835). The query processing device may add the graph of model elements to an output container (block 840). The query processing device may perform a check to determine if there are any remaining terms (block 845). If there are remaining terms, the query processing device may select another term (block 850) and return to block 810 to parse the selected term. If there are no more remaining terms, the query processing device may relate terms in a content group to one or more model elements, such as in block 745 of FIG. 7.

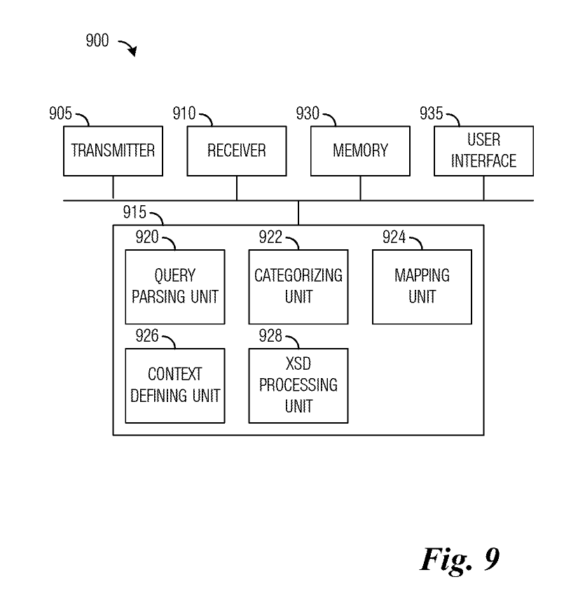

FIG. 9 provides an illustration of a device 900. Device 900 may be an implementation of a query processing device, a management entity, and the like. Device 900 may be used to implement various ones of the embodiments discussed herein. As shown in FIG. 9, a transmitter 905 is configured to send packets, frames, queries, and/or other types of data and commands and a receiver 910 is configured to receive packets, frames, queries, and/or other types of data and commands. In both cases, the data may include operational, administrative, management, and/or performance data and commands. Transmitter 905 and receiver 910 may have a wireless interface, a wireline interface, or a combination thereof.

A query parsing unit 920 is configured to parse queries into parts of speech tokens. Query parsing unit 920 is configured to validate queries. Categorizing unit 922 is configured to categorize parts of speech tokens into content tokens and context tokens. Mapping unit 924 is configured to map content tokens into sets of model elements. Mapping unit 924 is configured to determine relationships between context and content objects, relate terms in content groups to model elements, and to relate parts of speech terms to model elements. Mapping unit 924 is configured to map sets of model elements into XSD files. A context defining unit 926 is configured to define contexts to evaluate content tokens in the query. An XSD processing unit 928 is configured to combine XSD files into textual results. XSD processing unit 928 is configured to present the textual results in a human readable form.

A memory 930 is configured to store the models, queries, tokens, model elements, and the like. Memory 930 may be a physical memory, such as a disk drive, solid state memory, or a combination of the two. Memory 930 may be physically a part of device 900, it may be remotely located, or a combination of the two. Memory 930 may also consist of physical memory that is virtualized, thereby enabling multiple physical memory elements to be treated as a single pool of memory that can be allocated on an as-needed basis. A user interface 935 includes hardware and/or software to permit user interaction with device 900. As an example, user interface 935 includes a display, a keyboard, a touch pad, a voice recognition system, a speaker, a mouse, a stylus, and the like, to allow the user to interact with device 900.

The elements of device 900 may be implemented as specific hardware logic blocks. In an alternative, the elements of device 900 may be implemented as software executing in a processor, controller, application specific integrated circuit, or so on. In yet another alternative, the elements of communications device 900 may be implemented as a combination of software and/or hardware.

As an example, transmitter 905 and receiver 910 may be implemented as a specific hardware block, while query parsing unit 920, categorizing unit 922, mapping unit 924, context defining unit 926, and XSD processing unit 928 may be software modules executing in a processor 915, a microprocessor, a custom circuit, or a custom compiled logic array of a field programmable logic array. It is noted that processor 915, the microprocessor, the custom circuit, the custom compiled logic array, and the like, may be implemented in a multiple processing unit configuration that may be local to one another or distributed and coupled through a communications network. Query parsing unit 920, categorizing unit 922, mapping unit 924, context defining unit 926, and XSD processing unit 928 may be stored as modules in memory 930.

Although the present disclosure and its advantages have been described in detail, it should be understood that various changes, substitutions and alterations can be made herein without departing from the spirit and scope of the disclosure as defined by the appended claims.

What is claimed is:

1. A method for processing a query, the method comprising:
parsing, by a query processing device, the query into part of speech (POS) tokens;
categorizing, by the query processing device, the POS tokens into content tokens and context tokens;
mapping, by the query processing device, the content tokens to a first set of model elements;
mapping, by the query processing device, the context tokens to a second set of model elements;
mapping, by the query processing device, the first and second sets of model elements into a set of combined model elements; and
producing, by the query processing device, a set of extensible markup language (XML) schema definition(s) (XSD) files from the first, and second sets of model elements, and the set of combined model elements.

2. The method of claim 1, further comprising:
receiving the query;
parsing the query without error, thereby producing tokens;
storing the tokens resulting from parsing the query in an output container; and
validating that the query maps to at least one model element.

3. The method of claim 1, further comprising:
defining a set of context tokens to evaluate the content tokens of the query prior to mapping the content tokens to the first set of model elements; and
storing the set of context tokens in a first output container.

4. The method of claim 3, wherein defining a set of context tokens comprises:
producing a set of tokens by parsing the query to extract explicitly defined metadata;
producing a set of tokens by examining the query in conjunction with a set of explicitly defined metadata tokens to discover implicitly defined metadata; and
storing the set of explicitly defined metadata and the implicitly defined metadata as context tokens in a second output container.

5. The method of claim 1, further comprising combining the XSD files into a result.

6. The method of claim 5, wherein the result is suitable for display to a human user.

7. The method of claim 1, further comprising applying at least one of morphological pre-processing and lexical pre-processing to the query prior to parsing the query.

8. The method of claim 7, wherein applying the at least one of morphological pre-processing and lexical pre-processing comprises applying at least one of removal of stop words, removal of punctuation, removal of capitalization, removal of function words, and stemming.

9. The method of claim 1, wherein mapping the content tokens comprises:
applying a matching technique to map a set of content tokens to a third set of model elements; and
storing the third set of model elements into an output container.

10. The method of claim 9, wherein the matching technique comprises at least one of name recognition, identity recognition, feature-based matching, structure-based matching, behavior-based matching, and semantic relatedness matching.

11. The method of claim 1, wherein mapping the context tokens comprises:
determining relationships between the context tokens and the content tokens;
using the relationships between the content and context tokens to produce a combined set of tokens;
storing the combined set of tokens into a first output container;
mapping each of the tokens in the combined set of tokens to one or more model elements, producing a fourth set of model elements; and
storing the fourth set of model elements in a second output container.

12. The method of claim 11, wherein mapping the context tokens further comprises:
applying a matching technique to map a set of context tokens to a fifth set of model elements; and
storing the fifth set of model elements into a third output container.

13. The method of claim 12, wherein the matching technique comprises at least one of name recognition, identity recognition, feature-based matching, structure-based matching, behavior-based matching, and semantic relatedness matching.

14. The method of claim 11, wherein producing a set of combined model elements comprises:
matching the content tokens to a first graph of model elements;
matching the context tokens to a second graph of model elements;
producing the set of combined model elements by using a graph algorithm to combine the first graph of model elements with the second graph of model elements into a third graph of model elements; and
placing the third graph of model elements into a third output container.

15. The method of claim 1, wherein mapping the first and second sets of model elements further comprises:
combining and optimizing the first and second sets of model elements into the set of combined model elements.

16. The method of claim 1, wherein categorizing the POS tokens into content tokens and context tokens comprises:
parsing the query into POS tokens;
assigning all POS tokens that are either one of nouns and verbs into content tokens;
assigning all POS tokens that are not either one of nouns and verbs into context tokens;
storing the content tokens into a first output container; and
storing the context tokens into a second output container.

17. The method of claim 1, further comprising:
determining if an execution context is stated;
setting a default context as a system context when the execution context is not stated; and
setting the execution context as a combination of the system context and the context inferred by metadata when the execution context is stated.

18. A query processing device comprising:
a processor configured to parse a query into part of speech (POS) tokens, to categorize the POS tokens into content tokens and context tokens, to map the content tokens to a first set of model elements, to map the context tokens to a second set of model elements, to map the first and second sets of model elements into a set of combined model elements, and to produce a set of extensible markup language (XML) schema definition(s) (XSD) files from the first and second sets of model elements, and the set of combined model elements; and
a memory operatively coupled to the processor, the memory configured to store the query, the model elements, and the XSD files.

19. The query processing device of claim 18, further comprising a receiver operatively coupled to the processor, the receiver configured to receive the query, and wherein the processor is configured to parse the query without error to produce tokens, to store the tokens resulting from parsing the query in an output container, and to validate the query.

20. The query processing device of claim 18, wherein the processor is configured to define a set of context tokens to evaluate the content tokens of the query prior to mapping the content tokens to the first set of model elements, and to store the set of context tokens in a first output container.

21. The query processing device of claim 20, wherein the processor is configured to produce a set of tokens by parsing the query to extract explicitly defined metadata, to produce a set of tokens by examining the query in conjunction with a set of explicitly defined metadata tokens to discover implicitly defined metadata, and to store the set of explicitly defined metadata and the implicitly defined metadata as context tokens in a second output container.

22. The query processing device of claim 18, wherein the processor is configured to combine the XSD files into a result.

23. The query processing device of claim 18, wherein the processor is configured to apply at least one of morphological pre-processing and lexical pre-processing to the query prior to parsing the query.

24. The query processing device of claim 18, wherein the processor is configured to determine relationships between the context tokens and the content tokens, to use the relationships between the content and context tokens to produce a combined set of tokens, to store the combined set of tokens into a first output container, to map each of the tokens in the combined set of tokens to one or more model elements, producing a fourth set of model elements, and to storing the fourth set of model elements in a second output container.

25. The query processing device of claim 24, wherein the processor is configured to apply a matching technique to map a set of context tokens to a fifth set of model elements, and to store the fifth set of model elements into a third output container.

26. The query processing device of claim 24, wherein the processor is configured to match the content tokens to a first graph of model elements, to match the context tokens to a second graph of model elements, to produce the set of combined model elements by using a graph algorithms to combine the first graph of model elements with the second graph of model elements into a third graph of model elements, and to place the third graph of model elements into a third output container.

27. The query processing device of claim 18, wherein the processor is configured to combine and optimize the first and second set of model elements to produce the set of combined model elements.

28. The query processing device of claim 18, wherein the processor is configured to parse the query into POS tokens, to assign all POS tokens that are either one of nouns and verbs into content tokens, to assign all POS tokens that are not either one of nouns and verbs into context tokens, to store the content tokens into a first output container, and to store the context tokens into a second output container.

29. The query processing device of claim 18, wherein the processor is configured to determine if an execution context is stated, to set a default context as a system context when the execution context is not stated, and to set the execution context as a combination of the system context and the context inferred by metadata when the execution context is stated.

30. A management environment comprising:
a communications system being managed; and
a management entity operatively coupled to the communications system, the management entity configured to parse a query into part of speech (POS) tokens, to categorize the POS tokens into content tokens and context tokens, to map the content tokens to a first set of model elements, to map the context tokens to a second set of model elements, to map the first and second sets of model elements into a set of combined model elements, and to produce a set of extensible markup language (XML) schema definition(s) (XSD) files from the first and second sets of model elements, and the set of combined model elements.

31. The management environment of claim 30, wherein the management entity is configured to parse the query without error to produce tokens, to store the tokens resulting from parsing the query in an output container, and to validate the query.

32. The management environment of claim 30, wherein the management entity is configured to define a set of context tokens to evaluate the content tokens of the query prior to mapping the content tokens to the first set of model elements, and to store the set of context tokens in a first output container.

33. The management environment of claim 30, wherein the management entity is configured to determine relationships between the context tokens and the content tokens, to use the relationships between the content and context tokens to produce a combined set of tokens, to store the combined set of tokens into a first output container, to map each of the tokens in the combined set of tokens to one or more model elements, producing a fourth set of model elements, and to storing the fourth set of model elements in a second output container.

34. The management environment of claim 30, wherein the management entity is configured to parse the query into POS tokens, to assign all POS tokens that are either one of nouns and verbs into content tokens, to assign all POS tokens that are not either one of nouns and verbs into context tokens, to store the content tokens into a first output container, and to store the context tokens into a second output container.

35. The management environment of claim 30, wherein the management entity is configured to determine if an execution context is stated, to set a default context as a system context when the execution context is not stated, and to set the execution context as a combination of the system context and the context inferred by metadata when the execution context is stated.
